(19) United States
(12) Patent Application Publication
(10) Pub. No.: US 2025/0070225 A1
(43) Pub. Date: Feb. 27, 2025

(54) BATTERY

(71) Applicant: Panasonic Intellectual Property Management Co., Ltd., Osaka (JP)

(72) Inventors: NORIYUKI UCHIDA, Osaka (JP); EIICHI KOGA, Hokkaido (JP)

(21) Appl. No.: 18/946,944

(22) Filed: Nov. 14, 2024

Related U.S. Application Data
(63) Continuation of application No. PCT/JP2023/002791, filed on Jan. 30, 2023.

(30) Foreign Application Priority Data
May 26, 2022 (JP) 2022-085889

(51) Int. Cl. H01M 10/04

(52) U.S. Cl. CPC H01M 10/0468

(57) ABSTRACT

A battery including: a battery cell including a positive electrode, a negative electrode, and a solid electrolyte layer disposed between the positive electrode and the negative electrode; and a first pressing member in a plate shape provided above the battery cell to press the battery cell, in which the first pressing member includes a first surface in a planar shape that faces the battery cell, and a second surface in a convex shape that opposes the first surface.

### BACKGROUND

### 1. Technical Field

The present disclosure relates to a battery.

### 2. Description of the Related Art

Japanese Unexamined Patent Application Publication No. 2020-155244 discloses a battery in which an exterior body that is convex inward at its center applies pressure substantially uniformly to each of the front surface and the back surface of an electrode body of a battery cell using the elastic force of the exterior body.

Japanese Unexamined Patent Application Publication No. 2020-194743 discloses a battery including a pressing portion that locally presses at least one of the front surface and the back surface of an object (battery cell) accommodated in an exterior body.

### SUMMARY

In the related art, there has been a demand for a method of uniformly pressing a battery cell in order to improve performance by reducing the contact resistance of the battery cell. In Japanese Unexamined Patent Application Publication No. 2020-155244 and Japanese Unexamined Patent Application Publication No. 2020-194743, however, a load may concentrate on the surface of the battery cell in contact with the exterior body to cause damage to the battery cell when the battery cell is accommodated in the exterior body or when the battery cell is locally pressed. Therefore, it has been difficult to obtain a highly reliable battery.

One non-limiting and exemplary embodiment provides a highly reliable battery.

In one general aspect, the techniques disclosed here feature a battery including: a battery cell including a positive electrode, a negative electrode, and a solid electrolyte layer disposed between the positive electrode and the negative electrode; and a first pressing member in a plate shape provided above the battery cell to press the battery cell, in which the first pressing member includes a first surface in a planar shape that faces the battery cell, and a second surface in a convex shape that opposes the first surface.

According to the present disclosure, it is possible to provide a highly reliable battery.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view and a perspective view, respectively, of a plurality of battery cells of a battery according to a first embodiment;

FIG. 2 is a sectional view and a perspective view, respectively, of the battery according to the first embodiment;

FIG. 3 is a plan view, a front view, and a side view, respectively, of a first pressing member according to the first embodiment;

FIG. 4 is a perspective view of the first pressing member according to the first embodiment;

FIG. 5 is a perspective view in which the first pressing member according to the first embodiment and a circular column related to the shape of a curved surface are superposed;

FIG. 6 illustrates an accommodation process according to the first embodiment;

FIG. 7 is a sectional view in which constituent elements of the battery according to the first embodiment are spaced for illustration, and a side view of the first pressing member, respectively;

FIG. 8 is a sectional view illustrating a battery according to Comparative Example 1;

FIG. 9 is a sectional view of an exterior body and a battery unit of the battery according to the first embodiment;

FIG. 10 is a sectional view of a battery according to a modification of the first embodiment;

FIG. 11 is a plan view, a front view, and a side view, respectively, of a first pressing member according to Example 1 of the first embodiment;

FIG. 12 is a perspective view of the first pressing member according to Example 1 of the first embodiment;

FIG. 13 is a perspective view in which the first pressing member according to Example 1 of the first embodiment and a spherical body related to the shape of a curved surface are superposed;

FIG. 14 is a plan view, a front view, and a side view, respectively, of a first pressing member according to Example 2 of the first embodiment;

FIG. 15 is a perspective view of the first pressing member according to Example 2 of the first embodiment;

FIG. 16 is a front view and a perspective view, respectively, of a first pressing member according to Example 3 of the first embodiment;

FIG. 17 is a sectional view of a battery unit of a battery according to a second embodiment;

FIG. 18 is a perspective view of the battery unit of the battery according to the second embodiment;

FIG. 19 is a sectional view of a battery according to a third embodiment; and

FIG. 20 is a sectional view of a battery according to a fourth embodiment.

### DETAILED DESCRIPTIONS

### (Underlying Knowledge Forming Basis of the Present Disclosure)

One of the important qualities of a battery in which a plurality of battery cells are laminated, the battery cells each including a positive electrode current collector, a positive electrode active material layer, a negative electrode current collector, a negative electrode active material layer, and a solid electrolyte layer interposed between the positive electrode active material layer and the negative electrode active material layer, is high battery efficiency. The battery efficiency is improved by reducing the contact resistance of the battery cells by uniformly pressing the battery cells in the thickness direction.

However, an issue is occasionally caused when pressing the battery cells. For example, a consideration is given to a case where the center of an exterior body in contact with the battery cells to press the battery cells is convex inward or a case where the center of an exterior body is convex inward to locally press one of an upper surface and a lower surface of the battery cells. In this case, a load may concentrate on the surface of the battery cells in contact with the exterior body when the battery cells are accommodated in the exterior body or when the battery cells are locally pressed. This may cause damage to the battery cells, such as a reduction in the electrical conductivity due to rupture of the positive electrode active material layer, the negative electrode active material layer, and the solid electrolyte layer, a reduction in the electrical conductivity due to separation between layers of the battery cells, or tear of the positive electrode current collector or the negative electrode current collector. Therefore, it has been difficult to obtain a highly reliable battery.

Thus, the present disclosure provides a highly reliable battery.

A plurality of examples of the battery according to the present disclosure will be described below.

A first aspect of the present disclosure provides a battery including:
a battery cell including a positive electrode, a negative electrode, and a solid electrolyte layer disposed between the positive electrode and the negative electrode; and
a first pressing member in a plate shape provided above the battery cell to press the battery cell,
in which the first pressing member includes
   a first surface in a planar shape that faces the battery cell, and
   a second surface in a convex shape that opposes the first surface.

Consequently, it is possible to provide a highly reliable battery with high battery efficiency. Since the first surface of the first pressing member on the battery cell side is in a planar shape and the second surface is in a convex shape, deformation of the first surface in a planar shape is suppressed by a reaction force caused when the battery cell is pressed. Hence, the battery cell is uniformly pressed from above the battery cell by the first surface in a planar shape, and the occurrence of damage to the battery cell is suppressed. Thus, a highly reliable battery is achieved. Since the battery cell is pressed uniformly, it is possible to reduce the contact resistance of the battery cell, improving battery efficiency.

A second aspect of the present disclosure may provide, for example, the battery according to the first aspect, further including
an exterior body that accommodates the battery cell and the first pressing member,
in which the first pressing member is disposed between the exterior body and the battery cell.

Consequently, the battery cell is pressed by the exterior body via the first pressing member. Also in this case, the battery cell is pressed uniformly by the first pressing member, and therefore the occurrence of damage to the battery cell is suppressed. Thus, a highly reliable battery is achieved.

A third aspect of the present disclosure may provide, for example, the battery according to the second aspect, in which the first pressing member is more rigid than the exterior body.

Consequently, even if the first pressing member is pressed by the exterior body, the first surface of the first pressing member is less easily deformed. That is, the battery cell is pressed more uniformly by the first pressing member, and therefore the occurrence of damage to the battery cell is suppressed better. That is, a more reliable battery is achieved.

A fourth aspect of the present disclosure may provide, for example, the battery according to any one of the first to third aspects, further including
a second pressing member in a plate shape provided below the battery cell to press the battery cell,
in which the second pressing member includes
   a third surface in a planar shape that faces the battery cell, and
   a fourth surface that opposes the third surface.

Consequently, the battery cell is uniformly pressed from below the battery cell by the third surface in a planar shape. Hence, the battery cell is uniformly pressed from above and below the battery cell by the first surface in a planar shape and the third surface in a planar shape, and therefore the occurrence of damage to the battery cell is suppressed better. That is, a more reliable battery is achieved.

A fifth aspect of the present disclosure may provide, for example, the battery according to the fourth aspect, in which the fourth surface is in a planar shape.

Even if the fourth surface is in a planar shape in this manner, the battery cell is uniformly pressed from below the battery cell by the third surface in a planar shape. Hence, the battery cell is uniformly pressed from above and below the battery cell by the first surface in a planar shape and the third surface in a planar shape, and therefore the occurrence of damage to the battery cell is suppressed better. That is, a more reliable battery is achieved.

A sixth aspect of the present disclosure may provide, for example, the battery according to the fourth aspect, in which the second surface and the fourth surface have an identical shape.

Consequently, the first pressing member and the second pressing member have substantially the same shape. Therefore, it is not necessary to separately prepare the first pressing member and the second pressing member during production, simplifying the production.

A seventh aspect of the present disclosure may provide, for example, the battery according to the fourth aspect, in which the second surface and the fourth surface are shaped differently from each other.

Even if the second surface and the fourth surface are shaped differently from each other in this manner, the battery cell is uniformly pressed from below the battery cell by the third surface in a planar shape. Hence, the battery cell is uniformly pressed from above and below the battery cell by the first surface in a planar shape and the third surface in a planar shape, and therefore the occurrence of damage to the battery cell is suppressed better. That is, a more reliable battery is achieved.

An eighth aspect of the present disclosure may provide, for example, the battery according to any one of the fourth to seventh aspects, further including
an exterior body that accommodates the battery cell, the first pressing member, and the second pressing member,
in which the first pressing member and the second pressing member are more rigid than the exterior body.

Consequently, even if the first pressing member and the second pressing member are pressed by the exterior body, the first surface of the first pressing member and the third surface of the second pressing member are less easily deformed. That is, the battery cell is pressed more uniformly by the first pressing member and the second pressing member, and therefore the occurrence of damage to the battery cell is suppressed better. That is, a more reliable battery is achieved.

A ninth aspect of the present disclosure may provide, for example, the battery according to the second or third aspect,
in which a pressure inside the exterior body is lower than an atmospheric pressure.

Consequently, an external force to press the first pressing member is caused by the difference between the pressure inside the exterior body and the atmospheric pressure when the exterior body is constituted of laminate films. When the first pressing member is pressed by the external force, the battery cell is uniformly pressed from above the battery cell by the first surface in a planar shape, suppressing the occurrence of damage to the battery cell. Thus, a highly reliable battery is achieved.

A tenth aspect of the present disclosure may provide, for example, the battery according to the first aspect, including a plurality of battery cells,
in which the plurality of battery cells are laminated, and
the first pressing member is provided above an uppermost battery cell, of the plurality of battery cells.

Consequently, it is possible to provide a highly reliable battery with high battery efficiency. Also, in a laminated battery in which a plurality of battery cells are laminated, the plurality of battery cells are uniformly pressed from above by the first surface in a planar shape. Hence, the occurrence of damage to the plurality of battery cells is suppressed. Thus, a highly reliable battery is achieved. Since the plurality of battery cells are pressed uniformly, it is possible to reduce the contact resistance of the plurality of battery cells, improving battery efficiency.

An eleventh aspect of the present disclosure may provide, for example, the battery according to the tenth aspect, further including
a second pressing member in a plate shape provided below a lowermost battery cell, of the plurality of battery cells, to press the plurality of battery cells,
in which the second pressing member includes
   a third surface in a planar shape that faces the plurality of battery cells, and
   a fourth surface that opposes the third surface.

Consequently, the plurality of battery cells are uniformly pressed from below by the third surface in a planar shape. Hence, the plurality of battery cells are uniformly pressed from above and below by the first surface in a planar shape and the third surface in a planar shape, and therefore the occurrence of damage to the plurality of battery cells is suppressed better. That is, a more reliable battery is achieved.

A twelfth aspect of the present disclosure may provide, for example, the battery according to any one of the first to eleventh aspects,
in which the convex shape is a shape including a single curved surface, and
a shape of the single curved surface is a shape of a part of a spherical surface or a shape of a part of a side surface of a circular column.

Consequently, the battery cell is pressed more uniformly by the first pressing member, and therefore the occurrence of damage to the battery cell is suppressed better. That is, a more reliable battery is achieved.

A thirteenth aspect of the present disclosure may provide, for example, the battery according to any one of the first to eleventh aspects,
in which the convex shape is a shape including a plurality of curved surfaces, and
a shape of each of the plurality of curved surfaces is a shape of a part of a side surface of a circular column.

Consequently, the battery cell is pressed more uniformly by the first pressing member, and therefore the occurrence of damage to the battery cell is suppressed better. That is, a more reliable battery is achieved.

In the following, embodiments of the present disclosure will be specifically described with reference to the drawings.

The embodiments to be described below indicate comprehensive or specific examples. The numerical values, shapes, materials, constituent elements, arrangement positions and connection modes of the constituent elements, processes, order of the processes, etc. are exemplary, and are not intended to limit the present disclosure. Of the constituent elements in the following embodiments, constituent elements not set forth in the independent claims are described as optional constituent elements.

The drawings are schematic drawings, and are not necessarily drawn strictly to scale. Thus, the scales of the drawings do not necessarily coincide with each other, for example. In the drawings, substantially the same components are given the same reference numerals to omit or simplify redundant description.

Herein, terms that describe the relationship between elements such as parallel and orthogonal, terms that describe the shape of elements such as rectangular and rectangular parallelepiped, and numerical ranges do not only express their strict meaning, but also mean substantially equivalent ranges that allow a difference of about a few percent, for example.

In the specification and the drawings, the x-axis, the y-axis and the z-axis indicate the three axes of a three-dimensional orthogonal coordinate system. The x-axis and the z-axis coincide with directions parallel to a first side of a rectangle and a second side perpendicular to the first side, respectively, when battery cells of a battery has a rectangular shape when seen in the plan view. The y-axis coincides with the laminating direction of a plurality of battery cells.

Herein, the “laminating direction” coincides with the direction normal to the principal surfaces of a positive electrode, a negative electrode, and a solid electrolyte layer. The term “plan view” as used herein refers to a view seen in a direction perpendicular to the principal surface of the battery cells, unless otherwise stated, such as when used alone.

The terms “above” and “below” as used herein do not refer to an upper direction (vertically above) and a lower direction (vertically below) in absolute space recognition, but are used as terms prescribed by the relative positional relationship based on the laminating order in the laminating configuration. The terms “above” and “below” are applied not only when two constituent elements are spaced apart from each other with another constituent element interposed between the two constituent elements, but also when two constituent elements are disposed in close contact with each other. In the following description, the negative side of the y-axis is defined as “below” or “lower side” and the positive side of the y-axis is defined as “above” or “upper side”.

Herein, ordinal numbers such as “first” and “second” do not mean the number or order of constituent elements, but are used for the purpose of avoiding confusion between constituent elements of the same kind and differentiating the constituent elements, unless otherwise stated.

### FIRST EMBODIMENT

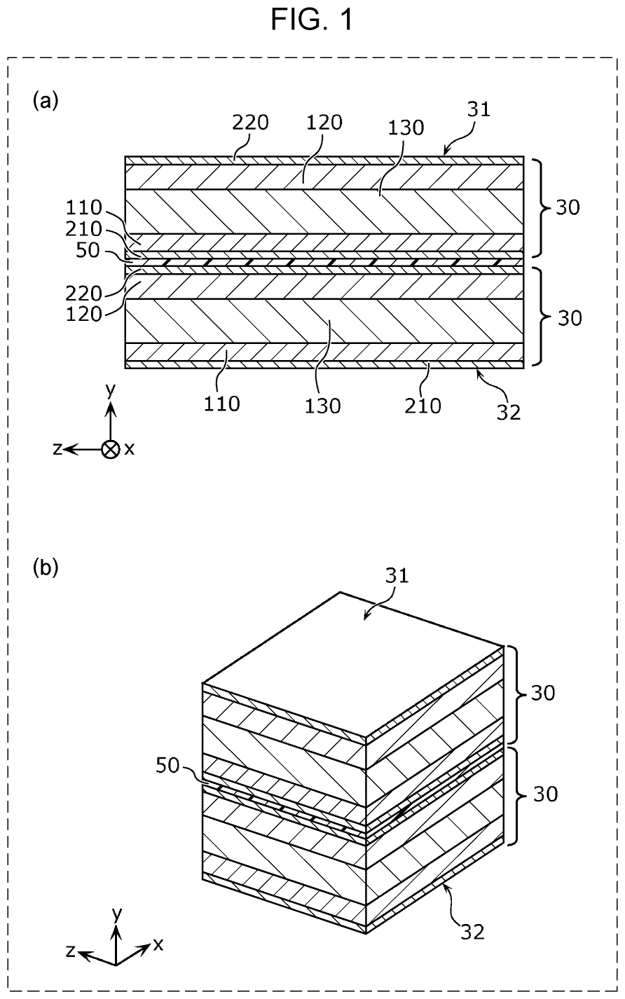

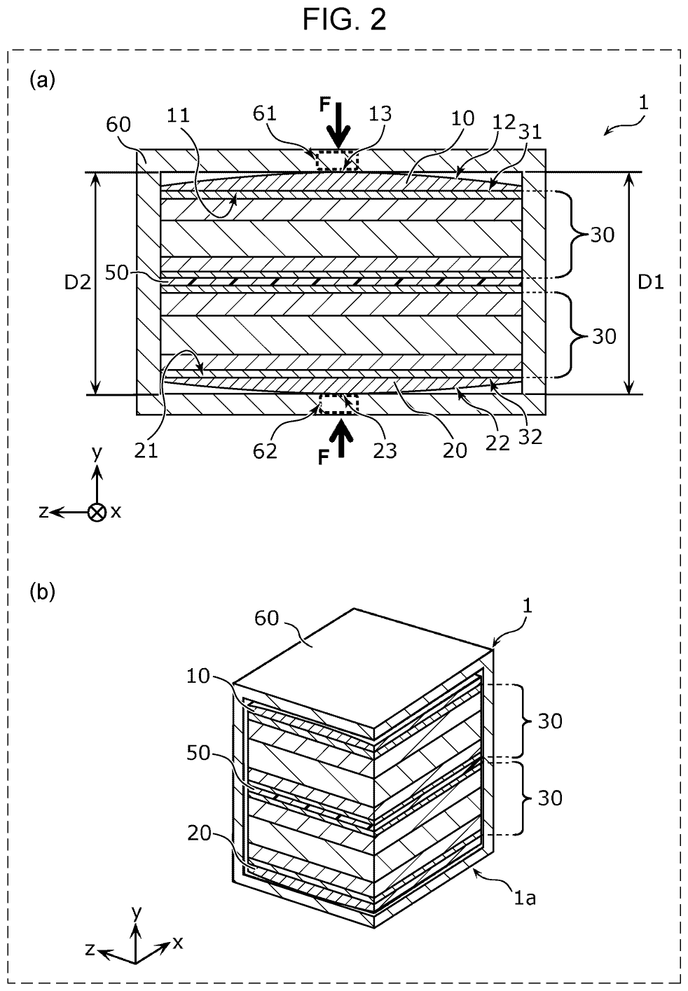

First, the configuration of a battery 1 according to a first embodiment will be described with reference to FIGS. 1 and 2.

FIG. 1 is a sectional view and a perspective view, respectively, of a plurality of battery cells 30 of the battery according to the first embodiment. FIG. 2 is a sectional view and a perspective view, respectively, of the battery 1 according to the first embodiment.

More specifically, FIG. 1(a) is a sectional view of the plurality of battery cells 30, and FIG. 1(b) is a perspective sectional view of the plurality of battery cells 30. FIG. 2(a) is a sectional view of the battery 1, and FIG. 2(b) is a perspective sectional view of the battery 1.

As illustrated in FIGS. 1 and 2, the battery 1 according to the first embodiment includes a plurality of battery cells 30, a conductive adhesive 50, a first pressing member 10, a second pressing member 20, and an exterior body 60. The battery 1 is a laminated battery in which the plurality of battery cells 30 are laminated. The plurality of battery cells 30 are electrically connected in series to constitute the battery 1. The plurality of battery cells 30, the conductive adhesive 50, the first pressing member 10, and the second pressing member 20 are occasionally collectively referred to as a “battery unit 1a”.

The battery is an all-solid-state battery. While the battery 1 includes a plurality of (two in the first embodiment) battery cells 30, this is not limiting. The battery 1 may include one or three or more battery cells 30.

Each of the plurality of battery cells 30 includes a positive electrode, a negative electrode, and a solid electrolyte layer 130 disposed between the positive electrode and the negative electrode. Here, the positive electrode includes a positive electrode active material layer 120 and a positive electrode current collector 220. The negative electrode includes a negative electrode current collector 210 and a negative electrode active material layer 110. The positive electrode, the negative electrode, and the solid electrolyte layer 130 correspond to a power generation element. That is, it may be said that each of the plurality of battery cells 30 includes a power generation element.

The negative electrode active material layer 110 and the positive electrode active material layer 120 face each other via the solid electrolyte layer 130. The positive electrode active material layer 120, the solid electrolyte layer 130, and the negative electrode active material layer 110 are laminated in this order along the thickness direction (negative y-axis direction) of the battery cell 30. More specifically, the positive electrode current collector 220, the positive electrode active material layer 120, the solid electrolyte layer 130, the negative electrode active material layer 110, and the negative electrode current collector 210 are laminated in this order along the thickness direction of the battery cell 30.

As described above, the battery 1 is a laminated battery that includes a plurality of battery cells 30 arranged in series. In the battery 1, the conductive adhesive 50 is provided between the negative electrode current collector 210 of one battery cell 30 (here, the battery cell 30 on the positive side of the y-axis) and the positive electrode current collector 220 of the other battery cell 30 (here, the battery cell 30 on the negative side of the y-axis). The conductivity between the plurality of battery cells 30 is secured by providing the conductive adhesive 50.

Examples of the negative electrode active material contained in the negative electrode active material layer 110 may include graphite and metal lithium. The material of the negative electrode active material may be various materials that allow removal and insertion of ions such as lithium (Li) or magnesium (Mg).

Examples of the material contained in the negative electrode active material layer 110 may include a solid electrolyte such as an inorganic solid electrolyte. A sulfide solid electrolyte or an oxide solid electrolyte, for example, may be used as the inorganic solid electrolyte. A mixture of lithium sulfide (Li₂S) and diphosphorus pentasulfide (P₂S₅), for example, may be used as the sulfide solid electrolyte. Examples of the material contained in the negative electrode active material layer 110 may include a conductive material such as acetylene black and a binder such as polyvinylidene fluoride.

The negative electrode active material layer 110 may be fabricated by applying a paste-like paint, obtained by kneading materials to be contained in the negative electrode active material layer 110 together with a solvent, onto a surface of the negative electrode current collector 210 and drying the paint. In order to increase the density of the negative electrode active material layer 110, a negative electrode plate that includes the negative electrode active material layer 110 and the negative electrode current collector 210 may be pressed after being dried. The thickness of the negative electrode active material layer 110 may be, but is not limited to, 5 μm or more and 300 μm or less, for example.

The positive electrode active material layer 120 is a layer containing a positive electrode material such as an active material, for example. The positive electrode material is a material that constitutes an electrode paired with the negative electrode material. The positive electrode active material layer 120 contains a positive electrode active material, for example.

Examples of the positive electrode active material contained in the positive electrode active material layer 120 may include lithium cobaltate composite oxide (LCO), lithium nickelate composite oxide (LNO), lithium manganate composite oxide (LMO), lithium-manganese-nickel composite oxide (LMNO), lithium-manganese-cobalt composite oxide (LMCO), lithium-nickel-cobalt composite oxide (LNCO), and lithium-nickel-manganese-cobalt composite oxide (LNMCO).

The material of the positive electrode active material may be various materials that allow removal and insertion of ions such as Li or Mg.

Examples of the material contained in the positive electrode active material layer 120 may include a solid electrolyte such as an inorganic solid electrolyte. A sulfide solid electrolyte or an oxide solid electrolyte, for example, may be used as the inorganic solid electrolyte. A mixture of Li₂S and P₂S₅, for example, may be used as the sulfide solid electrolyte. The surface of the positive electrode active material may be coated with a solid electrolyte. Examples of the material contained in the positive electrode active material layer 120 may include a conductive material such as acetylene black, carbon black, graphite, and carbon fibers and a binder such as polyvinylidene fluoride.

The positive electrode active material layer 120 may be fabricated by applying a paste-like paint, obtained by kneading materials to be contained in the positive electrode active material layer 120 together with a solvent, onto a surface of the positive electrode current collector 220 and drying the paint. In order to increase the density of the positive electrode active material layer 120, a positive electrode plate that includes the positive electrode active material layer 120 and the positive electrode current collector 220 may be pressed after being dried. The thickness of the positive electrode active material layer 120 may be, but is not limited to, 5 μm or more and 300 μm or less, for example.

The solid electrolyte layer 130 is disposed between the negative electrode active material layer 110 and the positive electrode active material layer 120. The solid electrolyte layer 130 is in contact with each of the negative electrode active material layer 110 and the positive electrode active material layer 120. The solid electrolyte layer 130 is a layer containing an electrolyte material. The electrolyte material may be a commonly known electrolyte for batteries. The thickness of the solid electrolyte layer 130 may be 5 μm or more and 300 μm or less, or may be 5 μm or more and 100 μm or less. The solid electrolyte layer 130 may contain a solid electrolyte.

The solid electrolyte may be an inorganic solid electrolyte, for example. A sulfide solid electrolyte or an oxide solid electrolyte, for example, may be used as the inorganic solid electrolyte. A mixture of Li₂S and P₂S₅, for example, may be used as the sulfide solid electrolyte. As the sulfide solid electrolyte, sulfides such as Li₂S—SiS₂, Li₂S—B₂S₃, or Li₂S—GeS₂ may also be used, or sulfides obtained by adding at least one of Li₃N, LiCl, LiBr, Li₃PO₄, and Li₄SiO₄ to the above sulfides as an additive may also be used. As the oxide solid electrolyte, materials capable of conducting lithium ions, such as Li₇La₃Zr₂O₁₂ (LLZ), Li_{1.3}Al_{0.3}Ti_{1.7} (PO₄)₃(LATP), or (La, Li)TiO₃ (LLTO), may be used, for example. The solid electrolyte layer 130 may contain a binder such as polyvinylidene fluoride, for example, in addition to the electrolyte material.

In the first embodiment, the negative electrode active material layer 110, the positive electrode active material layer 120, and the solid electrolyte layer 130 are maintained in the form of parallel flat plates.

The negative electrode current collector 210 and the positive electrode current collector 220 are each a conductive member. The negative electrode current collector 210 and the positive electrode current collector 220 may each be a conductive thin film, for example. Examples of the material that constitutes the negative electrode current collector 210 and the positive electrode current collector 220 may include metals such as stainless steel (SUS), aluminum (Al), copper (Cu), and nickel (Ni).

The negative electrode current collector 210 is disposed in contact with the negative electrode active material layer 110. A metal foil such as a SUS foil, a Cu foil, and a Ni foil, for example, may be used as the negative electrode current collector. The thickness of the negative electrode current collector 210 may be, but is not limited to, 5 μm or more and 100 μm or less, for example. The negative electrode current collector 210 may include a current collector layer that is a layer containing a conductive material, for example, in a portion in contact with the negative electrode active material layer 110.

While the battery cells 30 have a rectangular shape when seen in the plan view as illustrated in FIGS. 1 and 2, this is not limiting.

Subsequently, the conductive adhesive 50 will be described.

The conductive adhesive 50 is a layer for bonding two adjacent battery cells 30, and may be a conductive adhesive paste, a conductive adhesive film, or an anisotropic conductive film, for example. The conductive adhesive paste is a paste-like adhesive obtained by dispersing conductive particles in a thermosetting adhesive resin material such as an epoxy resin, an acrylic resin, or a urethane resin, for example. The conductive adhesive film and the anisotropic conductive film are obtained by dispersing conductive particles in a thermosetting adhesive resin material and forming the material in the form of a film.

Further, the first pressing member 10 will be described.

The first pressing member 10 is a member provided above the battery cells 30. The first pressing member 10 is provided above the uppermost battery cell 30 (here, the battery cell 30 on the positive side of the y-axis), of the plurality of battery cells 30. Here, when the principal surface, on the positive side of the y-axis, of the battery cell 30, on the positive side of the y-axis, is defined as an upper surface 31, the first pressing member 10 is provided in contact with the upper surface 31 of the battery cell 30.

The first pressing member 10 is a plate-shaped member that includes a first surface 11 that faces the battery cell 30 and a second surface 12 that opposes the first surface 11, and presses the battery cell 30 (here, the plurality of battery cells 30).

The first surface 11 is a principal surface in a planar shape that faces the battery cell 30 (i.e., a surface that faces downward). That is, the first surface 11 which is a surface in contact with the upper surface 31 of the battery cell 30 is a flat surface having no asperities or protrusions.

The second surface 12 is a principal surface in a convex shape that faces the side opposite to the battery cell 30 (i.e., a surface that faces upward). The convex surface may be constituted of one or more curved surfaces, or may be constituted of a combination of a plurality of flat surfaces. The convex shape may also be said as a dome shape.

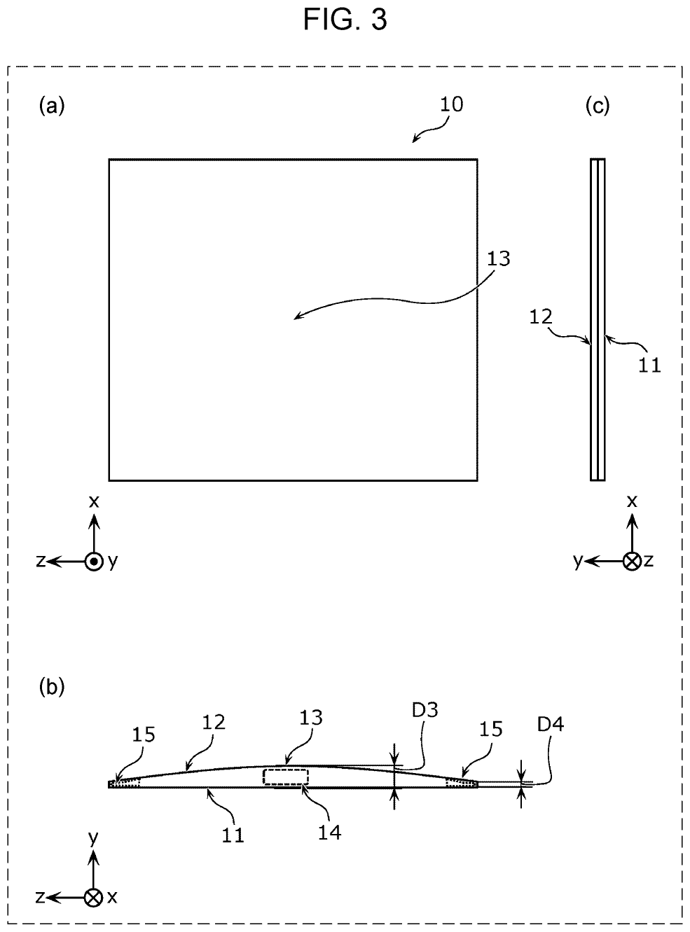

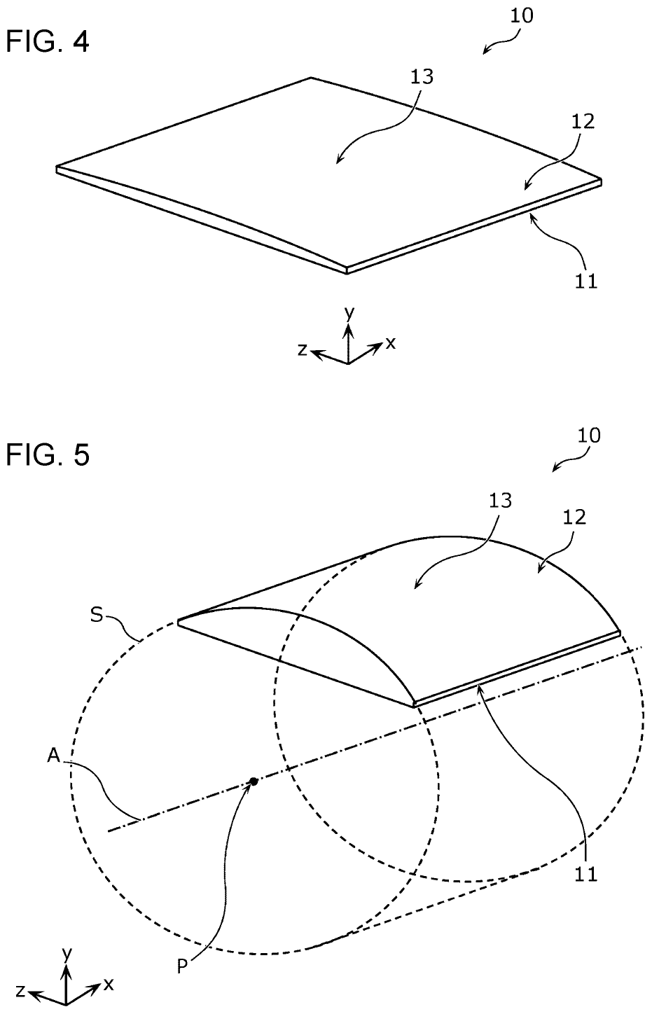

Here, the second surface 12 according to the first embodiment will be described with reference to FIGS. 3 and 4.

FIG. 3 is a plan view, a front view, and a side view, respectively, of the first pressing member 10 according to the first embodiment. More specifically, FIG. 3(a) is a plan view of the first pressing member 10, FIG. 3(b) is a front view of the first pressing member 10, and FIG. 3(c) is a side view of the first pressing member 10. FIG. 4 is a perspective view of the first pressing member 10 according to the first embodiment.

The convex shape of the second surface 12 according to the first embodiment is a shape including a single curved surface, more specifically a shape constituted of a single curved surface alone. The convex shape according to the first embodiment is a shape projecting in the positive y-axis direction, that is, projecting upward. More specifically, the shape of the single curved surface is the shape of a part of a side surface of a circular column.

Here, the shape of the single curved surface will be described.

When the first pressing member 10 is seen from one direction (x-axis direction), that is, seen in the front view, as illustrated in FIG. 3(b), the second surface 12 is formed in an arch-like shape, or may be said to be formed in an arcuate shape. On the other hand, when the first pressing member 10 is seen from another direction (z-axis direction), that is, seen in the side view, as illustrated in FIG. 3(c), the second surface 12 is formed in a straight shape.

The shape of the single curved surface is the shape of a part of a side surface of a circular column, more specifically the shape of a portion obtained by cutting off a part of a circular column along a central axis at a position on the outer side with respect to the central axis. This will be described in more detail with reference to FIG. 5.

FIG. 5 is a perspective view in which the first pressing member 10 according to the first embodiment and a circular column S related to the shape of the curved surface are superposed.

In the first pressing member 10 illustrated in FIG. 5, the convex shape of the second surface 12 is exaggerated, that is, illustrated as projecting to a greater degree in the positive y-axis direction, for illustration. As illustrated in FIG. 5, the shape of the single curved surface as the convex shape of the second surface 12 coincides with the shape of a portion obtained by cutting off a part of the circular column S along a central axis A at a position on the outer side with respect to the central axis A. In other words, it may be said that the single curved surface is a curved surface in a cylindrical shape.

As illustrated in FIGS. 2 to 5, the convex shape (single curved surface) is provided on the entire second surface 12. That is, in other words, the second surface 12 does not include a region that is not in the convex shape.

When the shape of the single curved surface is the shape of a part of a side surface of a circular column, the direction in which the single curved surface extends is a direction parallel to the central axis A of the circular column S, and is the x-axis direction in the first embodiment. The central axis A passes through a center P of a bottom surface of the circular column S. The shape of the single curved surface is the shape of a portion obtained by cutting of a part of the circular column S along the central axis A at a position on the outer side with respect to the central axis A, and is occasionally referred to as a “semi-cylindrical shape”. While the two bottom surfaces of the circular column S related to the shape of the curved surface are in a perfect circle shape, this is not limiting. The bottom surfaces may be in an elliptical shape.

Further, as illustrated in FIG. 3(b), the convex shape of the second surface 12 includes a vertex portion 13 at a center portion 14 of the second surface 12 as seen in the front view. In FIG. 3(b), the center portion 14 and end portions 15 of the first pressing member 10 are indicated as rectangles in broken lines.

The thickness of the first pressing member 10 is greatest at the center portion 14 as viewed in the front view, and becomes smaller toward the end portions 15. Specifically, as illustrated in FIG. 3(b), a thickness D3 of the center portion 14 at which the vertex portion 13 is located is greater than a thickness D4 of the end portions 15. In other words, when seen in the front view, the first pressing member 10 is shaped such that the thickness of the first pressing member 10 increases continuously from the end portions 15 toward the center portion 14. Alternatively, when seen in the front view, the first pressing member 10 may be shaped such that the thickness of the first pressing member 10 increases stepwise from the end portions 15 toward the center portion 14.

The plan view shape of the first pressing member 10 is rectangular, as with the plan view shape of the battery cell 30. The size of the first pressing member 10 when seen in the plan view is the same as the size of the battery cell 30 when seen in the plan view. That is, in the first embodiment, the first surface 11 of the first pressing member 10 covers all the upper surface 31 of the battery cell 30. The plan view shape of the first pressing member 10 is not limited thereto. In the first embodiment, the convex shape (single curved surface) is provided on the entire second surface 12, and therefore it may be said that the convex shape of the second surface 12 is provided in all the region in which the battery cell 30 and the first pressing member 10 are superposed when seen in the plan view.

The first pressing member 10 is desirably constituted of a metal material or a resin material. While the first pressing member 10 is desirably constituted of a stainless steel material as the metal material, for example, this is not limiting. The first pressing member 10 is desirably constituted of aluminum as the metal material or a resin material, for the purpose of weight reduction. The first pressing member 10 is desirably more rigid than the exterior body 60. The materials that constitute the first pressing member 10 and the exterior body 60 are desirably determined in consideration of longitudinal elastic moduli and section moduli, for example. In order for the first pressing member 10 to achieve high rigidity, the first pressing member 10 advantageously has a higher longitudinal elastic modulus. The first pressing member 10 is desirably constituted of a material with a higher clastic modulus, and the thickness of the first pressing member 10 is desirably greater, for example. This contributes to higher rigidity.

Next, the second pressing member 20 will be described.

As illustrated in FIG. 2, the second pressing member 20 is a member provided below the battery cells 30. The second pressing member 20 is provided below the lowermost battery cell 30 (here, the battery cell 30 on the negative side of the y-axis), of the plurality of battery cells 30. Here, when the principal surface, on the negative side of the y-axis, of the battery cell 30, on the negative side of the y-axis, is defined as a lower surface 32, the second pressing member 20 is provided in contact with the lower surface 32 of the battery cell 30.

The second pressing member 20 is a plate-shaped member that includes a third surface 21 that faces the battery cell 30 and a fourth surface 22 that opposes the third surface 21, and presses the battery cell 30 (here, the plurality of battery cells 30).

The third surface 21 is a principal surface in a planar shape that faces the battery cell 30 (i.e., a surface that faces upward). That is, the third surface 21 which is a surface in contact with the lower surface 32 of the battery cell 30 is a flat surface having no asperities or protrusions.

The fourth surface 22 is a principal surface that faces the side opposite to the battery cell 30 (i.e., a surface that faces downward). In the first embodiment, the fourth surface 22 is a surface in a convex shape, and the second surface 12 and the fourth surface 22 have the same shape. That is, the first pressing member 10 and the second pressing member 20 according to the first embodiment have substantially the same shape, and the shape of the second pressing member 20 coincides with a shape obtained by inverting the first pressing member 10 in the vertical direction (y-axis direction).

As illustrated in FIG. 2, the convex shape of the fourth surface 22 is a shape projecting in the negative y-axis direction, that is, projecting downward, and includes a vertex portion 23 around the center of the fourth surface 22 when seen in the front view. The convex shape (single curved surface) is provided on the fourth second surface 22. That is, in other words, the fourth surface 22 does not include a region that is not in the convex shape.

The plan view shape of the second pressing member 20 is rectangular, as with the plan view shape of the battery cell 30. The size of the second pressing member 20 when seen in the plan view is the same as the size of the battery cell 30 when seen in the plan view. That is, in the first embodiment, the third surface 21 of the second pressing member 20 covers all the lower surface 32 of the battery cell 30. The plan view shape of the second pressing member 20 is not limited thereto. In the first embodiment, the convex shape (single curved surface) is provided on the entire fourth surface 22, and therefore it may be said that the convex shape of the fourth surface 22 is provided in all the region in which the battery cell 30 and the second pressing member 20 are superposed when seen in the plan view.

The second pressing member 20 is desirably constituted of a metal material or a resin material, as with the first pressing member 10. While the second pressing member 20 is desirably constituted of a stainless steel material as the metal material, for example, this is not limiting. The second pressing member 20 is desirably constituted of aluminum as the metal material or a resin material, for the purpose of weight reduction. The second pressing member 20 is desirably more rigid than the exterior body 60. The materials that constitute the second pressing member 20 and the exterior body 60 are desirably determined in consideration of longitudinal elastic moduli and section moduli, for example. In order for the second pressing member 20 to achieve high rigidity, the second pressing member 20 advantageously has a higher longitudinal elastic modulus. The second pressing member 20 is desirably constituted of a material with a higher elastic modulus, and the thickness of the second pressing member 20 is desirably greater, for example. This contributes to higher rigidity.

Further, the exterior body 60 will be described.

The exterior body 60 is a container that accommodates the battery cells 30, the first pressing member 10, and the second pressing member 20. In the first embodiment, the exterior body 60 accommodates the battery unit 1a (the plurality of battery cells 30, the conductive adhesive 50, the first pressing member 10, and the second pressing member 20).

Here, the exterior body 60 is a container in a rectangular can shape. The exterior body 60 is desirably constituted of a metal material, but may be constituted of a resin material. Examples of the metal material include aluminum, an aluminum alloy, iron, and stainless steel. The exterior body 60 may be constituted of a plurality of laminate films, for example.

Since the exterior body 60 is in a rectangular can shape, it may be said that the exterior body 60 has a rectangular parallelepiped shape. Therefore, the sectional shape of the exterior body 60 is a rectangular frame shape as illustrated in FIG. 2, and two side walls, an upper wall located on the positive side of the y-axis, and a bottom wall located on the negative side of the y-axis are indicated in FIG. 2. A portion around the center of the upper wall of the exterior body 60 is defined as an upper wall center portion 61, and a portion around the center of the bottom wall of the exterior body 60 is defined as a bottom wall center portion 62.

Here, as illustrated in FIG. 2, the lengths in the y-axis direction of the battery unit 1a (the plurality of battery cells 30, the conductive adhesive 50, the first pressing member 10, and the second pressing member 20) and the exterior body 60 are defined as a length D1 and a length D2, respectively.

More specifically, the length D1 of the battery unit 1a corresponds to the distance in the y-axis direction between the vertex portion 13 of the first pressing member 10 and the vertex portion 23 of the second pressing member 20. The length D2 of the exterior body 60 corresponds to the inside dimension in the y-axis direction between the upper wall of the exterior body 60 and the bottom wall of the exterior body 60.

Before the battery unit 1a is accommodated in the exterior body 60, the length D2 of the exterior body 60 is slightly shorter than the length D1 of the battery unit 1a. After the battery unit 1a is accommodated in the exterior body 60, the length D2 of the exterior body 60 coincides with the length D1 of the battery unit 1a.

Next, a method of producing the battery 1 will be described.

In the first embodiment, as illustrated in FIG. 2, the battery unit 1a (the plurality of battery cells 30, the conductive adhesive 50, the first pressing member 10, and the second pressing member 20) is accommodated in the exterior body 60. The method of producing the battery 1 includes preparing such a battery unit 1a.

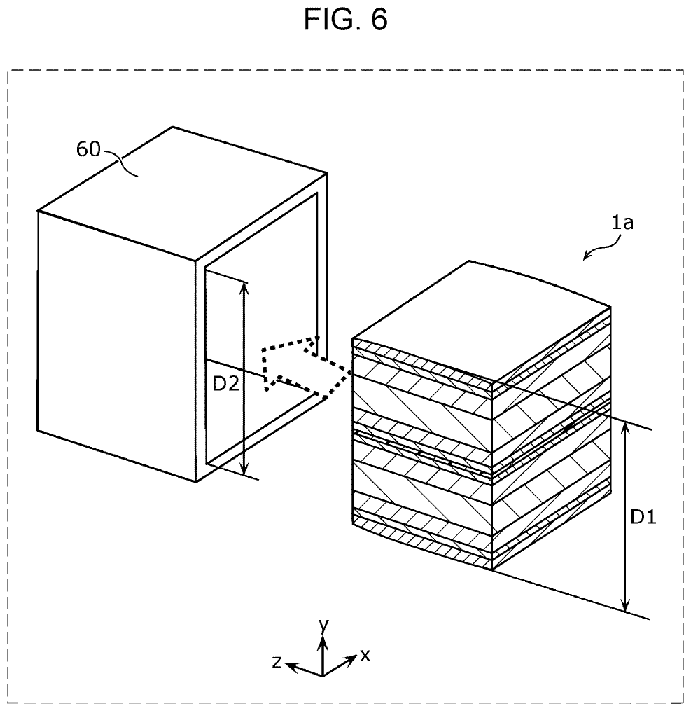

Next, the production method will be described with reference to FIG. 6.

FIG. 6 illustrates an accommodation process according to the first embodiment.

The production method includes a step in which the battery unit 1a (the plurality of battery cells 30, the conductive adhesive 50, the first pressing member 10, and the second pressing member 20) is accommodated in the exterior body 60, as illustrated in FIG. 6.

Before the battery unit 1a is accommodated in the exterior body 60, the length D2 of the exterior body 60 is slightly shorter than the length D1 of the battery unit 1a, as described above. Therefore, the battery unit 1a is accommodated in the exterior body 60 by pushing the battery unit 1a into the exterior body 60 while applying a force. At this time, the exterior body 60 may be slightly deformed.

The vertex portion 13 of the first pressing member 10 and the vertex portion 23 of the second pressing member 20 accommodated in this step are in contact with the upper wall center portion 61 and the bottom wall center portion 62, respectively, of the exterior body 60, as illustrated in FIG. 2. More specifically, the vertex portion 13 is in contact with the inside surface of the upper wall center portion 61, and the vertex portion 23 is in contact with the inside surface of the bottom wall center portion 62.

As described above, the length D2 is slightly shorter than the length D1 before the battery unit 1a is accommodated. Therefore, due to this contact, the first pressing member 10 receives an external force F in the negative y-axis direction applied by the upper wall center portion 61, and the second pressing member 20 receives an external force F in the positive y-axis direction applied by the bottom wall center portion 62. Hence, the first surface 11 of the first pressing member 10 presses the upper surface 31 of the battery cell 30, and the third surface 31 of the second pressing member 20 presses the lower surface 32 of the battery cell 30, sandwiching the battery cells 30.

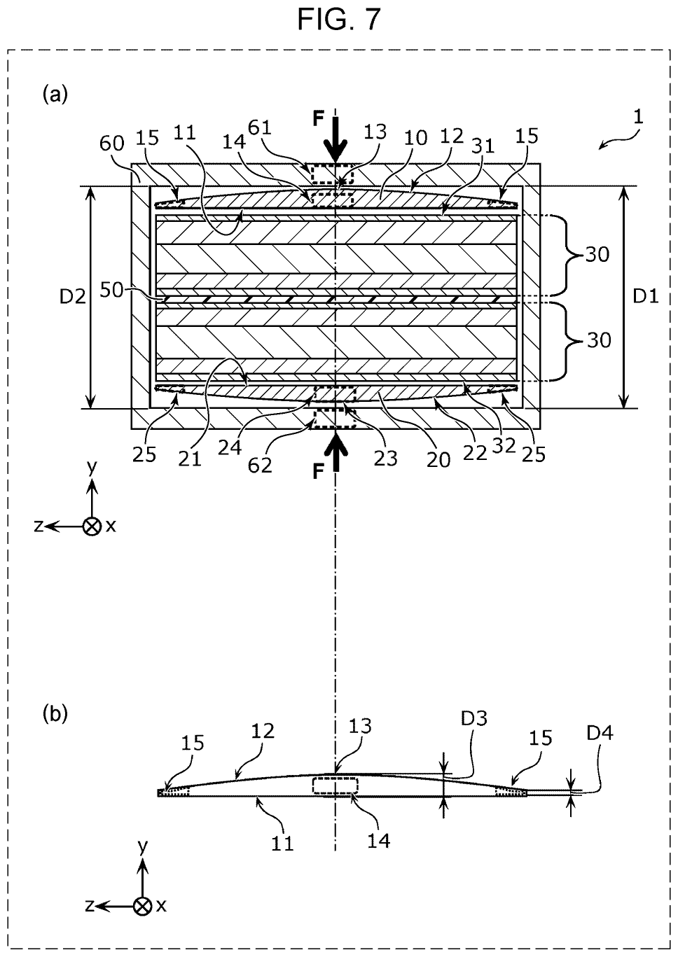

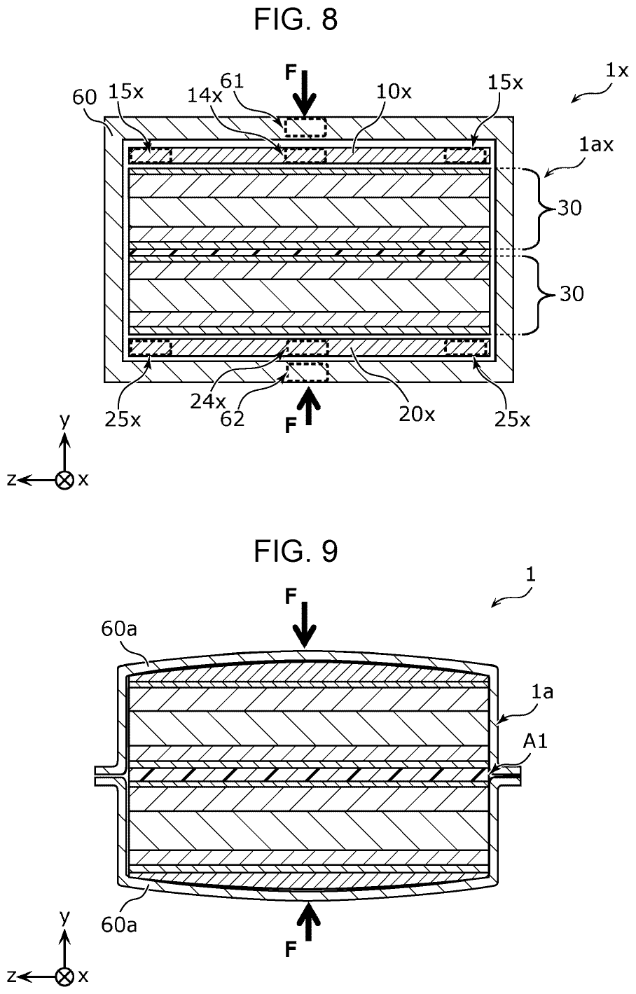

Here, a comparison is made between the battery 1 according to the first embodiment and a battery 1x according to a comparative example with reference to FIGS. 7 and 8.

FIG. 7 is a sectional view in which constituent elements of the battery 1 according to the first embodiment are spaced for illustration, and a side view of the first pressing member 10, respectively. FIG. 8 is a sectional view of the battery 1x according to Comparative Example 1.

FIG. 7(a) is a sectional view in which constituent elements of the battery 1 are spaced for illustration, and FIG. 7(b) is a front view of the first pressing member 10. In FIG. 7(a), the exterior body 60 is spaced from the first pressing member 10 and the second pressing member 20, and the first pressing member 10 and the second pressing member 20 are spaced from the plurality of battery cells 30, for illustration.

As illustrated in FIG. 7, and as described with reference to FIG. 2, the first surface 11 of the first pressing member 10 is in a planar shape, and the second surface 12 of the first pressing member 10 is constituted of a single curved surface (a part of a side surface of a circular column) alone. Hence, the thickness D3 of the center portion 14 of the first pressing member 10 is greater than the thickness D4 of the end portions 15 of the first pressing member 10.

The battery 1x according to the comparative example illustrated in FIG. 8 includes a battery unit 1ax and the exterior body 60. The battery unit 1ax has the same configuration as the battery unit 1a, except for including a first pressing member 10x and a second pressing member 20x in place of the first pressing member 10 and the second pressing member 20.

A first surface 11x and a second surface 12x of the first pressing member 10x are each in a planar shape, and are each a flat surface having no asperities or protrusions.

A third surface 21x and a fourth surface 22x of the second pressing member 20x are each in a planar shape, and are each a flat surface having no asperities or protrusions.

A center portion 14x and end portions 15x of the first pressing member 10x are indicated as rectangles in broken lines in FIG. 8. Similarly, a center portion 24x and end portions 25x of the second pressing member 20x are indicated as rectangles in broken lines in FIG. 8.

In the first pressing member 10x, the thickness of the center portion 14x is equal to the thickness of the end portions 15x as seen in the front view. In the second pressing member 20x, the thickness of the center portion 24x is equal to the thickness of the end portions 25x as seen in the front view.

As illustrated in FIG. 8, the battery 1x includes the first pressing member 10x and the second pressing member 20x. Consequently, when the battery unit 1ax according to the comparative example is accommodated in the exterior body 60, external forces F from the exterior body 60 are applied to the battery unit 1ax. In this case, the force with which the first pressing member 10x and the second pressing member 20x press the plurality of battery cells 30 is greater at the end portions 15x and the end portions 25x, and smaller at the center portion 14x and the center portion 24x.

As a result, a pressing force, that is, a load, concentrates at the end portions 15x and the end portions 25x, causing damage to the battery 1x. The term “damage” as used herein means that at least one of the positive electrode active material layer 120, the negative electrode active material layer 110, and the solid electrolyte layer 130 is ruptured and the electrical conductivity is reduced at the location of the rupture, for example. The term may also mean that the positive electrode active material layer 120 separates from the positive electrode current collector 220, the negative electrode active material layer 110 separates from the negative electrode current collector 210, or one of the battery cells 30 separates from another battery cell 30 and the electrical conductivity is reduced at the location of the separation, for example. The term may also mean that at least one of the positive electrode current collector 220 and the negative electrode current collector 210 is torn, for example. Since the battery 1x may be damaged in this manner, it is difficult for the battery 1x to be highly reliable.

On the contrary, the battery 1 according to the first embodiment includes battery cells 30 and a first pressing member 10. The battery 1 includes a plurality of battery cells 30. The battery cells 30 each include a positive electrode, a negative electrode, and a solid electrolyte layer 130 disposed between the positive electrode and the negative electrode. The first pressing member 10 is a plate-shaped member provided above the battery cells 30 to press the battery cells 30. The first pressing member 10 includes a first surface 11 in a planar shape that faces the battery cells 30 and a second surface 12 in a convex shape that opposes the first surface 11.

As described above, the first surface 11 of the first pressing member 10 on the battery cell 30 side is in a planar shape and the second surface 12 is in a convex shape, that is, the second surface 12 projects upward. Therefore, the thickness of the first pressing member 10 is great compared to when the second surface 12 does not project, for example. Therefore, even if external forces F are applied to the first pressing member 10, the first pressing member 10 is not easily deformed, or more specifically, the first surface 11 in a planar shape is not easily deformed, by a reaction force of the external forces F. That is, the first pressing member 10 can press the battery cells 30 uniformly from above the battery cells 30 without deforming the first surface 11 in a planar shape. Therefore, the occurrence of damage to the battery cells 30 is suppressed. That is, a highly reliable battery 1 is achieved. Since the battery cells 30 are pressed uniformly, it is possible to reduce the contact resistance of the battery cells 30, improving battery efficiency.

In the first embodiment, further, as illustrated in FIG. 3, the thickness D3 of the center portion 14 at which the vertex portion 13 is located is greater than the thickness D4 of the end portions 15. In other words, when seen in the front view, the first pressing member 10 is shaped such that the thickness of the first pressing member 10 increases continuously from the end portions 15 toward the center portion 14. Consequently, a substantially uniform stress is caused in the x-axis direction and the z-axis direction, allowing the first pressing member 10 to uniformly press the battery cells 30 from above the battery cells 30 without deforming the first surface 11 in a planar shape. When the battery cells 30 have a size of 2 cm by 2 cm when seen in the plan view and a load in such a range that no problem is caused to the use of the battery is applied, for example, it is possible to reduce the weight of the first pressing member 10 by about 20% compared to the first pressing member 10x.

In the first embodiment, further, the vertex portion 13 of the second surface 12 in a convex shape is located at the center portion 14 of the second surface 12. When a container in a rectangular can shape is used as the exterior body 60, for example, the vertex portion 13 as the most projecting portion is pressed in contact with the exterior body 60. More specifically, the vertex portion 13 located at the center portion 14 is pressed by the upper wall center portion 61 of the exterior body 60. Consequently, the first pressing member 10 may press the battery cells 30 more uniformly from above the battery cells 30.

The plan view shape of the first pressing member 10 is rectangular, as with the plan view shape of the battery cell 30. Hence, in the first embodiment, the first surface 11 of the first pressing member 10 covers all the upper surface 31 of the battery cell 30. That is, when the vertex portion 13 located at the center portion 14 is pressed by the upper wall center portion 61 of the exterior body 60, the first surface 11 presses all the upper surface 31 of the battery cell 30. Consequently, the first pressing member 10 may press the battery cells 30 more uniformly from above the battery cells 30.

The battery 1 according to the first embodiment includes the exterior body 60 which accommodates the battery cells 30 and the first pressing member 10. The first pressing member 10 is disposed between the exterior body 60 and the battery cells 30.

Consequently, the battery cells 30 are pressed by the exterior body 60 via the first pressing member 10. Also in this case, the battery cells 30 are pressed uniformly by the first pressing member 10, and therefore the occurrence of damage to the battery cells 30 is suppressed. That is, a highly reliable battery 1 is achieved.

In the battery 1 according to the first embodiment, the first pressing member 10 is more rigid than the exterior body 60.

Consequently, even if the first pressing member 10 is pressed by the exterior body 60, the first surface 11 of the first pressing member 10 is less easily deformed. That is, the battery cells 30 are pressed more uniformly by the first pressing member 10, and therefore the occurrence of damage to the battery cells 30 is suppressed better. That is, a more reliable battery 1 is achieved.

The battery 1 according to the first embodiment includes the second pressing member 20 in a plate shape provided below the battery cells 30 to press the battery cells 30. The second pressing member 20 includes a third surface 21 in a planar shape that faces the battery cells 30 and a fourth surface 22 that opposes the third surface 21.

Consequently, the battery cells 30 are uniformly pressed from below the battery cells 30 by the third surface 21 in a planar shape. Hence, the battery cells 30 are uniformly pressed from above and below the battery cells 30 by the first surface 11 in a planar shape and the third surface 21 in a planar shape, and therefore the occurrence of damage to the battery cells 30 is suppressed better. That is, a more reliable battery 1 is achieved.

In the battery 1 according to the first embodiment, the second surface 12 and the fourth surface 22 have the same shape.

Consequently, the first pressing member 10 and the second pressing member 20 have substantially the same shape. Therefore, it is not necessary to separately prepare the first pressing member 10 and the second pressing member 20 during production, simplifying the production.

The battery 1 according to the first embodiment includes the exterior body 60 which accommodates the battery cells 30, the first pressing member 10, and the second pressing member 20. The first pressing member 10 and the second pressing member 20 are more rigid than the exterior body 60.

Consequently, even if the first pressing member 10 and the second pressing member 20 are pressed by the exterior body 60, the first surface 11 of the first pressing member 10 and the third surface 21 of the second pressing member 20 are less casily deformed. That is, the battery cells 30 are pressed more uniformly by the first pressing member 10 and the second pressing member 20, and therefore the occurrence of damage to the battery cells 30 is suppressed better. That is, a more reliable battery 1 is achieved.

The battery 1 according to the first embodiment includes a plurality of battery cells 30. The plurality of battery cells 30 are laminated. The first pressing member 10 is provided above the uppermost battery cell 30 (the battery cell 30 on the positive side of the y-axis in the first embodiment), of the plurality of battery cells 30.

Consequently, it is possible to provide a highly reliable battery 1 with high battery efficiency. Also, in a laminated battery (battery 1) in which a plurality of battery cells are laminated, the plurality of battery cells 30 are uniformly pressed from above by the first surface 11 in a planar shape. Hence, the occurrence of damage to the plurality of battery cells 30 is suppressed. That is, a highly reliable battery 1 is achieved. Since the plurality of battery cells 30 are pressed uniformly, it is possible to reduce the contact resistance of the plurality of battery cells 30, improving battery efficiency.

The battery 1 according to the first embodiment includes the second pressing member 20 in a plate shape provided below the lowermost battery cell 30 (the battery cell 30 on the negative side of the y-axis in the first embodiment), of the plurality of battery cells 30, to press the plurality of battery cells 30. The second pressing member 20 includes a third surface 21 in a planar shape that faces the plurality of battery cells 30 and a fourth surface 22 that opposes the third surface 21.

Consequently, the plurality of battery cells 30 are uniformly pressed from below by the third surface 21 in a planar shape. Hence, the plurality of battery cells 30 are uniformly pressed from above and below by the first surface 11 in a planar shape and the third surface 21 in a planar shape, and therefore the occurrence of damage to the plurality of battery cells 30 is suppressed better. That is, a more reliable battery 1 is achieved.

In the battery 1 according to the first embodiment, the convex shape is a shape including a single curved surface. The shape of the single curved surface is the shape of a part of a side surface of the circular column S.

Consequently, the battery cells 30 are pressed more uniformly by the first pressing member 10, and therefore the occurrence of damage to the battery cells 30 is suppressed better. That is, a more reliable battery 1 is achieved.

The exterior body 60 is not limited to a container in a rectangular can shape. For example, the battery 1 may include an exterior body 60a constituted of two laminate films, in place of the exterior body 60. FIG. 9 is a sectional view of the exterior body 60a and the battery unit 1a of the battery 1 according to the first embodiment. In this manner, the external forces F may be applied to the first pressing member 10 and the second pressing member 20 with the battery unit 1a wrapped in the exterior body 60a constituted of two laminate films.

The inside of the exterior body 60a is a gap region between the exterior body 60a and the battery unit 1a, or a region A1 indicated in FIG. 9. In the battery 1 illustrated in FIG. 9, the pressure inside the exterior body 60a, that is, the pressure in the region A1, is lower than the atmospheric pressure. The inside (region A1) wrapped by the two laminate films as the exterior body 60a is desirably at a negative pressure, which is lower than the pressure outside the exterior body 60a.

In this manner, the pressure inside the exterior body 60a is desirably lower than the atmospheric pressure.

Consequently, the external forces F to press the first pressing member 10 and the second pressing member 20 are caused by the difference between the pressure inside the exterior body 60a (region A1) and the atmospheric pressure. When the first pressing member 10 and the second pressing member 20 are pressed, the battery cells 30 are uniformly pressed from above and below the battery cells 30 by the first surface 11 and the third surface 21 in a planar shape. Thus, the occurrence of damage to the battery cells 30 is suppressed. That is, a highly reliable battery 1 is achieved.

In particular, the external forces F become greater as the difference between the pressure inside the exterior body 60a and the atmospheric pressure is larger, reducing the contact resistance to a greater degree.

By using the exterior body 60a, it is possible to make use of the elastic force of the exterior body 60a when the upper surface 31 and the lower surface 32 of the plurality of battery cells 30 are pressed substantially uniformly. Therefore, there is no need for a separate component for pressing the battery 1, downsizing the battery 1.

### Modifications

Next, the configuration of a battery 1b according to a modification of the first embodiment will be described. The modification of the first embodiment is different from the first embodiment in the configuration of a second pressing member 20b. In the following, differences will be described, and the description of commonalities will be omitted or simplified.

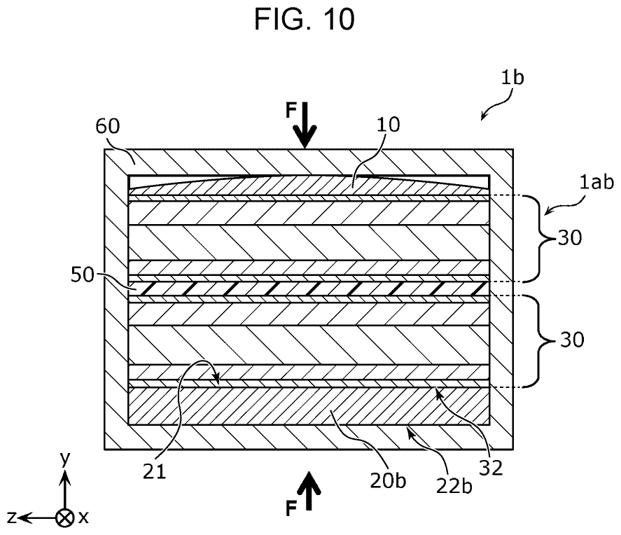

FIG. 10 is a sectional view of the battery 1b according to the modification of the first embodiment. As illustrated in FIG. 10, the battery 1b includes a battery unit lab that includes a plurality of battery cells 30, a conductive adhesive 50, a first pressing member 10, and a second pressing member 20b, and an exterior body 60.

A fourth surface 22b of the second pressing member 20b is in a planar shape. The second pressing member 20b has the same configuration as the second pressing member 20 except that the fourth surface 22b is a principal surface in a planar shape and a flat surface having no asperities or protrusions.

Also when the fourth surface 22b of the second pressing member 20b of the battery 1b according to the modification is in a planar shape in this manner, the battery cells 30 are uniformly pressed from below the battery cells 30 by the third surface 21 in a planar shape. Hence, the battery cells 30 are uniformly pressed from above and below the battery cells 30 by the first surface 11 in a planar shape and the third surface 21 in a planar shape, and therefore the occurrence of damage to the battery cells 30 is suppressed better. That is, a more reliable battery 1b is achieved.

The shape of the first pressing member 10 is not limited to the above. Other examples of the first pressing member according to the first embodiment will be described below. In the following description of Examples 1 to 3 of the first embodiment, differences between respective first pressing members according to Examples 1 to 3 of the first embodiment and the first pressing member 10 according to the first embodiment will be described, and the description of commonalities will be omitted or simplified.

### Example 1

First, the configuration of a first pressing member 10c according to Example 1 of the first embodiment will be described.

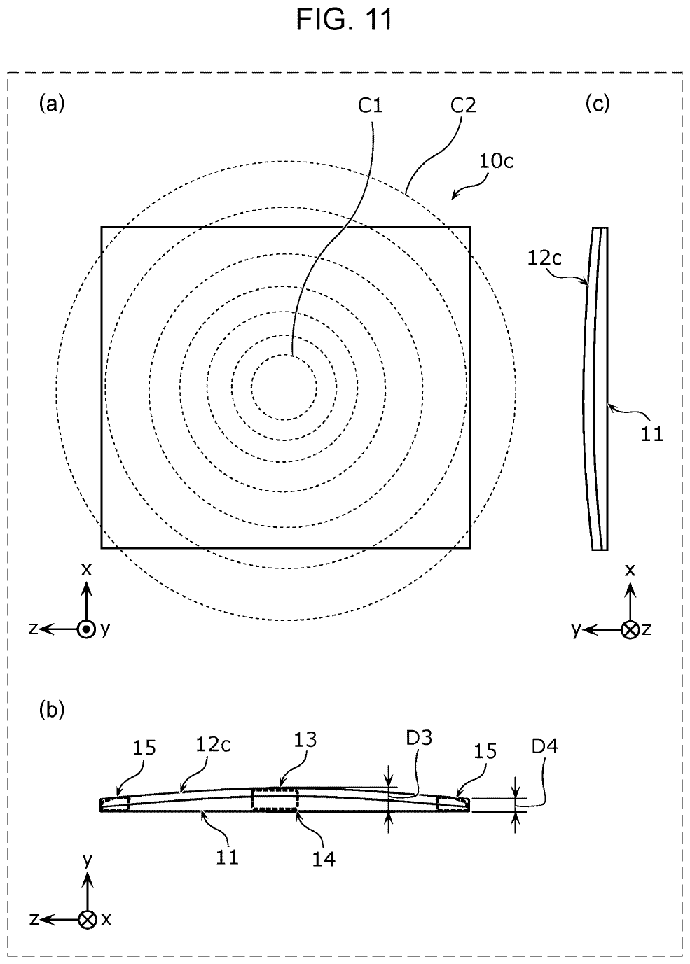

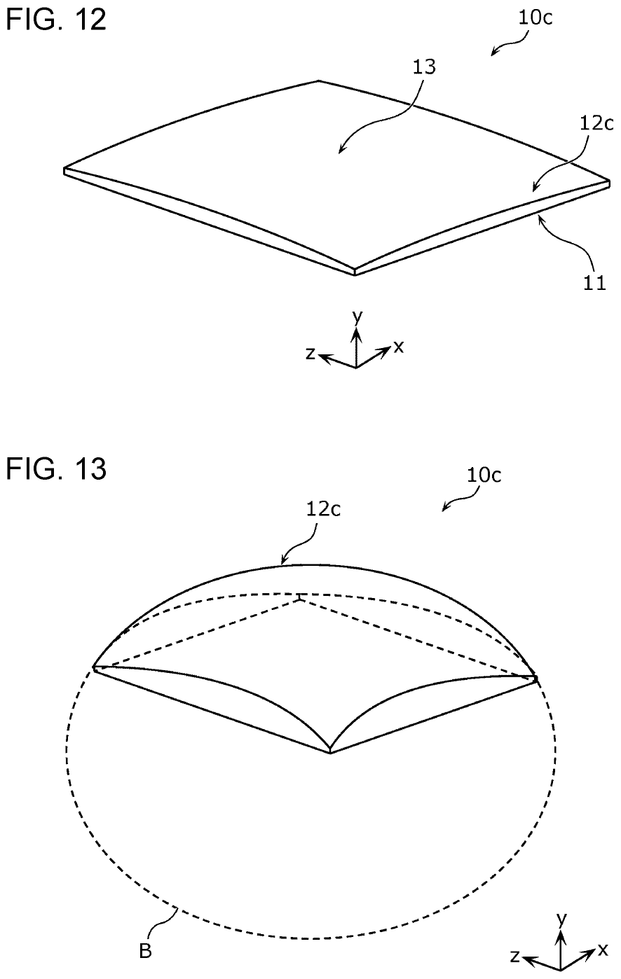

FIG. 11 is a plan view, a front view, and a side view, respectively, of the first pressing member 10c according to Example 1 of the first embodiment. More specifically, FIG. 11(a) is a plan view of the first pressing member 10c, FIG. 11(b) is a front view of the first pressing member 10c, and FIG. 11(c) is a side view of the first pressing member 10c. FIG. 12 is a perspective view of the first pressing member 10c according to Example 1 of the first embodiment.

The first pressing member 10c is a member that includes the first surface 11 and a second surface 12c. The convex shape of the second surface 12c according to Example 1 of the first embodiment is a shape including a single curved surface, more specifically a shape constituted of a single curved surface alone. The convex shape according to Example 1 of the first embodiment is a shape projecting in the positive y-axis direction, that is, projecting upward. More specifically, the shape of the single curved surface is the shape of a part of a spherical surface.

When the first pressing member 10c is seen from one direction (x-axis direction), that is, seen in the front view, as illustrated in FIG. 11(b), the second surface 12c is formed in an arch-like shape. Similarly, when the first pressing member 10c is seen from another direction (z-axis direction), that is, seen in the side view, as illustrated in FIG. 11(c), the second surface 12c is formed in an arch-like shape.

FIG. 13 is a perspective view in which the first pressing member 10c according to Example 1 of the first embodiment and a spherical body B related to the shape of the curved surface are superposed.

In the first pressing member 10c illustrated in FIG. 13, the convex shape of the second surface 12c is exaggerated, that is, illustrated as projecting to a greater degree in the positive y-axis direction, for illustration. As illustrated in FIG. 13, the shape of the single curved surface as the convex shape of the second surface 12c coincides with the shape of a surface obtained by cutting off a part of the spherical body B.

As illustrated in FIGS. 11 to 13, the convex shape (single curved surface) is provided on the entire second surface 12c. That is, the second surface 12c does not include a region that is not in the convex shape, for example.

The second surface 12c will be further described with reference to FIG. 11.

FIG. 11(a) illustrates a plurality of virtual circles indicated by dot-and-dash lines. Each virtual line is a line constituted of a collection of points at which the distance in the y-axis direction between the first surface 11 and the second surface 12 is the same, and is a so-called contour line. The innermost virtual circle is defined as a virtual circle C1, and the outermost virtual circle is defined as a virtual circle C2. The distance in the y-axis direction between the first surface 11 and the second surface 12 becomes shorter from the virtual circle C1 toward the virtual circle C2. That is, as illustrated in FIG. 11(b), the thickness D3 of the center portion 14 at which the vertex portion 13 is located is greater than the thickness D4 of the end portions 15. Also, in FIG. 11(c), the thickness of the center portion is greater than the thickness of the end portions.

In this manner, the first pressing member 10c according to Example 1 of the first embodiment includes a first surface 11 in a planar shape and a second surface 12c in a convex shape. The convex shape of the second surface 12c is a shape including a single curved surface, and the shape of the single curved surface is the shape of a part of a spherical surface.

Consequently, the battery cells are pressed more uniformly by the first pressing member 10c, and therefore the occurrence of damage to the battery cells is suppressed better. That is, a more reliable battery is achieved.

### Example 2

Next, the configuration of a first pressing member 10d according to Example 2 of the first embodiment will be described.

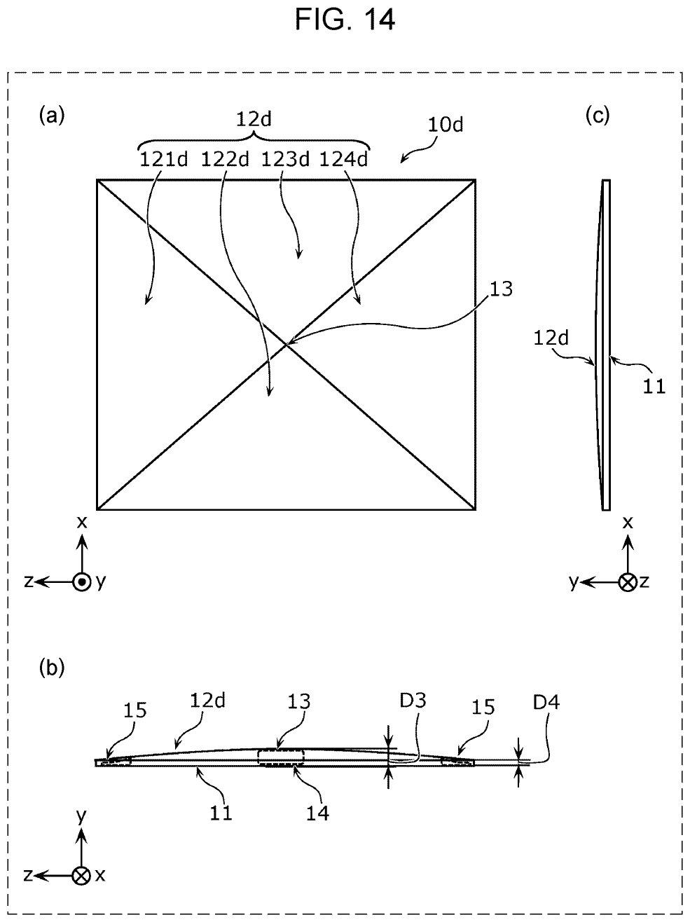

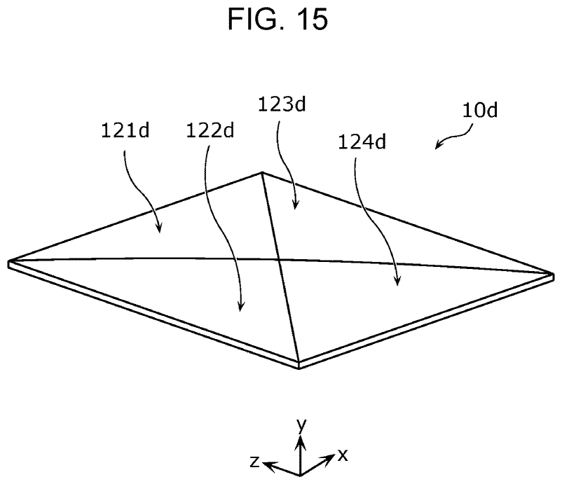

FIG. 14 is e a plan view, a front view, and a side view, respectively, of the first pressing member 10d according to Example 2 of the first embodiment. More specifically, FIG. 14(a) is a plan view of the first pressing member 10d, FIG. 14(b) is a front view of the first pressing member 10d, and FIG. 14(c) is a side view of the first pressing member 10d. FIG. 15 is a perspective view of the first pressing member 10d according to Example 2 of the first embodiment.

The first pressing member 10d is a member that includes the first surface 11 and a second surface 12d. The convex shape of the second surface 12d according to Example 2 of the first embodiment is a shape including a plurality of curved surfaces, more specifically a shape constituted of four curved surfaces alone. The convex shape according to Example 2 of the first embodiment is a shape projecting in the positive y-axis direction, that is, projecting upward.

Here, the four curved surfaces are defined as curved surfaces 121d, 122d, 123d, and 124d. As illustrated in FIG. 14(a), the planar shape of the first pressing member 10d is a rectangular shape, and the four curved surfaces 121d to 124d correspond to regions separated by diagonal lines of the rectangular shape.

Here, the shape of two curved surfaces diagonal to each other when seen in the plan view is the shape of a part of a side surface of a circular column. More specifically, the shape of the two curved surfaces 121d and 124d diagonal to each other constitutes the shape of a part of a side surface of one circular column, and the shape of the two curved surfaces 122d and 123d diagonal to each other constitutes the shape of a part of a side surface of another circular column. The central axis of the one circular column is parallel to the x-axis direction, and the central axis of the other circular column is parallel to the z-axis direction. That is, the central axis of the one circular column and the central axis of the other circular column intersect each other, and more specifically are orthogonal to each other.

When the first pressing member 10d is seen from one direction (x-axis direction), that is, seen in the front view, as illustrated in FIG. 14(b), the second surface 12d is formed in an arch-like shape. Similarly, when the first pressing member 10d is seen from another direction (z-axis direction), that is, seen in the side view, as illustrated in FIG. 14(c), the second surface 12d is formed in an arch-like shape.

As illustrated in FIGS. 14 and 15, the convex shape (four curved surfaces 121d to 124d) is provided on the entire second surface 12d. That is, the second surface 12d does not include a region that is not in the convex shape, for example.

As illustrated in FIG. 14(b), the thickness D3 of the center portion 14 at which the vertex portion 13 is located is greater than the thickness D4 of the end portions 15. Also, in FIG. 14(c), the thickness of the center portion is greater than the thickness of the end portions.

In this manner, the first pressing member 10d according to Example 2 of the first embodiment includes a first surface 11 in a planar shape and a second surface 12d in a convex shape. The convex shape of the second surface 12d is a shape including a plurality of curved surfaces (more specifically, four curved surfaces 121d to 124d), and the shape of the plurality of curved surfaces is the shape of a part of a side surface of a circular column.

Consequently, the battery cells are pressed more uniformly by the first pressing member 10d, and therefore the occurrence of damage to the battery cells is suppressed better. That is, a more reliable battery is achieved.

### Example 3

Further, the configuration of a first pressing member 10f according to Example 3 of the first embodiment will be described.

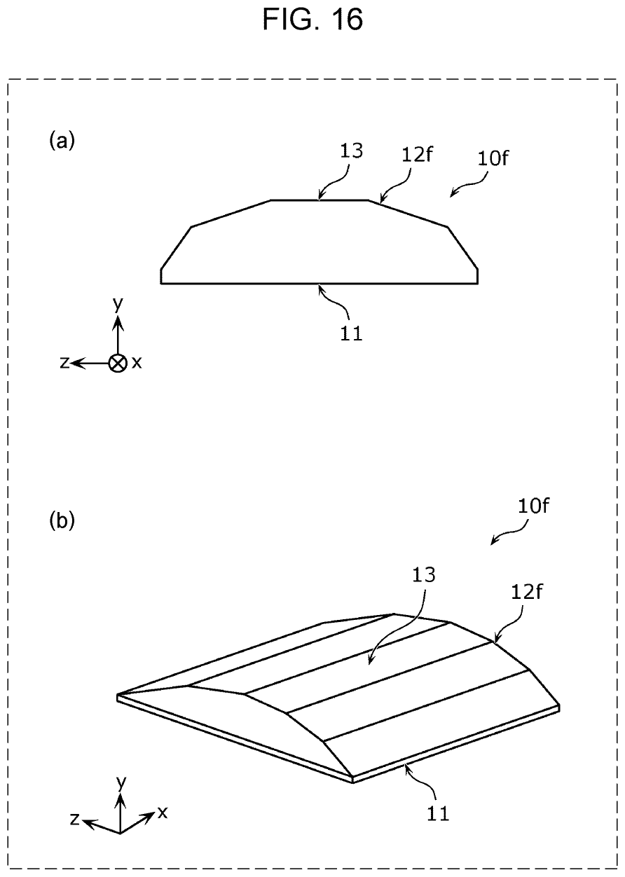

FIG. 16 is a front view and a perspective view, respectively, of the first pressing member 10f according to Example 3 of the first embodiment. More specifically, FIG. 16(a) is a front view of the first pressing member 10f, and FIG. 16(b) is a perspective view of the first pressing member 10f.

The first pressing member 10f is a member that includes the first surface 11 and a second surface 12f. The convex shape of the second surface 12f according to Example 3 of the first embodiment is a shape constituted of a combination of a plurality of flat surfaces, more specifically a shape constituted of five flat surfaces alone. The convex shape according to Example 3 of the first embodiment is a shape projecting in the positive y-axis direction, that is, projecting upward. The five flat surfaces are surfaces extending in the x-axis direction.

When the first pressing member 10f is seen from one direction (x-axis direction), that is, seen in the front view, as illustrated in FIG. 16(a), the second surface 12f is formed in an arch-like shape.

As illustrated in FIG. 16, the convex shape (five flat surfaces) is provided on the entire second surface 12f. That is, the second surface 12f does not include a region that is not in the convex shape, for example.

As illustrated in FIG. 16(a), the thickness of the center portion at which the vertex portion 13 is located is greater than the thickness of the end portions.

In this manner, the first pressing member 10f according to Example 3 of the first embodiment includes a first surface 11 in a planar shape and a second surface 12f in a convex shape. The convex shape of the second surface 12f is a shape constituted of a combination of a plurality of flat surfaces.

Consequently, the battery cells are pressed more uniformly by the first pressing member 10f, and therefore the occurrence of damage to the battery cells is suppressed better. That is, a more reliable battery is achieved.

As described in relation to Examples 1 to 3, the shape of the first pressing member is not limited to the shape of the first pressing member 10 described in relation to the first embodiment. The second pressing member also may have substantially the same configuration as the first pressing members 10c, 10d, and 10f. For example, a battery that includes a second pressing member that has substantially the same configuration as the first pressing member 10c and the first pressing member 10 described in relation to the first embodiment may be achieved.

In such a battery, the second surface and the fourth surface are shaped differently from each other. Even if the second surface and the fourth surface are shaped differently from each other in this manner, the battery cells are uniformly pressed from below the battery cells by the third surface in a planar shape. Hence, the battery cells are uniformly pressed from above and below the battery cells by the first surface in a planar shape and the third surface in a planar shape, and therefore the occurrence of damage to the battery cells is suppressed better. That is, a more reliable battery is achieved.

The shape of the first pressing member is not limited to the examples described in relation to the first embodiment and Examples 1 to 3, and a shape that provides a stress that does not deform the first surface, which is a flat surface, of the first pressing member by varying a geometrical moment of inertia may be achieved in consideration of cost, etc.

### Second Embodiment

Next, the configuration of a battery 1g according to a second embodiment will be described. The second embodiment is different from the first embodiment in the configuration of a first pressing member 10g and a second pressing member 20g. In the following, differences will be described, and the description of commonalities will be omitted or simplified.

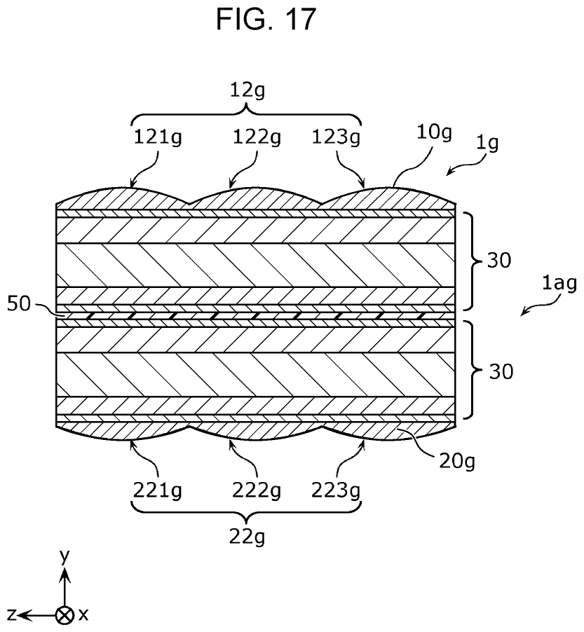

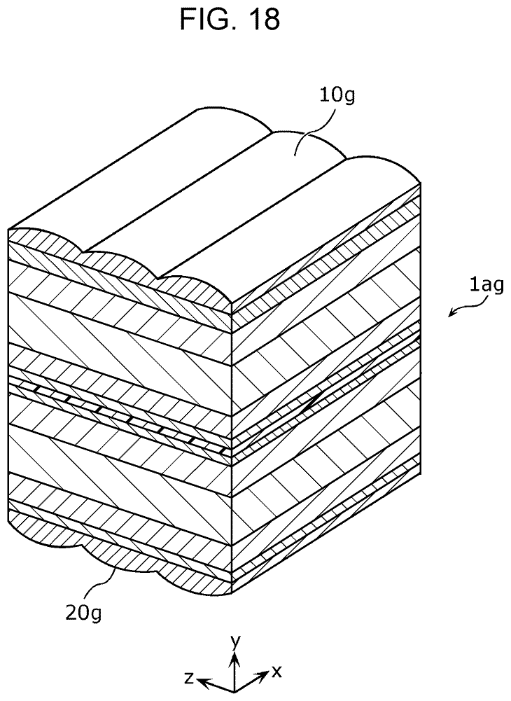

FIG. 17 is a sectional view of a battery unit lag of the battery 1g according to the second embodiment. FIG. 18 is a perspective view of the battery unit lag of the battery 1g according to the second embodiment. The battery 1g according to the second embodiment includes a battery unit lag that includes a plurality of battery cells 30, a conductive adhesive 50, a first pressing member 10g, and a second pressing member 20g, and an exterior body (not illustrated). The exterior body according to the second embodiment has the same configuration as the exterior body 60 according to the first embodiment.

A second surface 12g of the first pressing member 10g is a principal surface in a convex shape. The convex shape of the second surface 12g is a shape including a plurality of curved surfaces, more specifically a shape constituted of three curved surfaces 121g, 122g, and 123g alone. The convex shape according to the second embodiment is a shape projecting in the positive y-axis direction, that is, projecting upward. More specifically, the shape of each of the plurality of curved surfaces is the shape of a part of a side surface of a circular column. Here, the central axis of the circular column is parallel to the x-axis direction. That is, the central axes of the plurality of (here, three) circular columns related to the plurality of curved surfaces are arranged in parallel.

The second pressing member 20g according to the second embodiment has substantially the same shape as the first pressing member 10g, and the shape of the second pressing member 20g coincides with a shape obtained by inverting the first pressing member 10g in the vertical direction (y-axis direction). That is, a fourth surface 22g of the second pressing member 20g is a principal surface in a convex shape, and the convex shape of the fourth surface 22g is a shape constituted of three curved surfaces 221g, 222g, and 223g alone.

In the first pressing member 10g, each of the three curved surfaces 121g to 123g is provided with a vertex portion, that is, the convex shape of the second surface 12g has three vertex portions. In the second pressing member 20g, similarly, each of the three curved surfaces 221g to 223g is provided with a vertex portion, that is, the convex shape of the fourth surface 22g has three vertex portions. When the battery unit lag is inserted into an exterior body, the three vertex portions of the first pressing member 10g and the three vertex portions of the second pressing member 20g are in contact with the exterior body.

In this manner, the first pressing member 10g according to the second embodiment includes a first surface 11 in a planar shape and a second surface 12g in a convex shape. The convex shape of the second surface 12g is a shape including a plurality of curved surfaces (more specifically, three curved surfaces 121g to 123g), and the shape of each of the plurality of curved surfaces is the shape of a part of a side surface of a circular column.

Consequently, the battery cells 30 are pressed more uniformly by the first pressing member 10g, and therefore the occurrence of damage to the battery cells 30 is suppressed better. That is, a more reliable battery 1g is achieved.

### Third and Fourth Embodiments

Next, the configuration of a battery 1h and a battery 1j according to third and fourth embodiments will be described. The third and fourth embodiments are different from the first embodiment in including insulating layers 70. In the following, differences will be described, and the description of commonalities will be omitted or simplified.

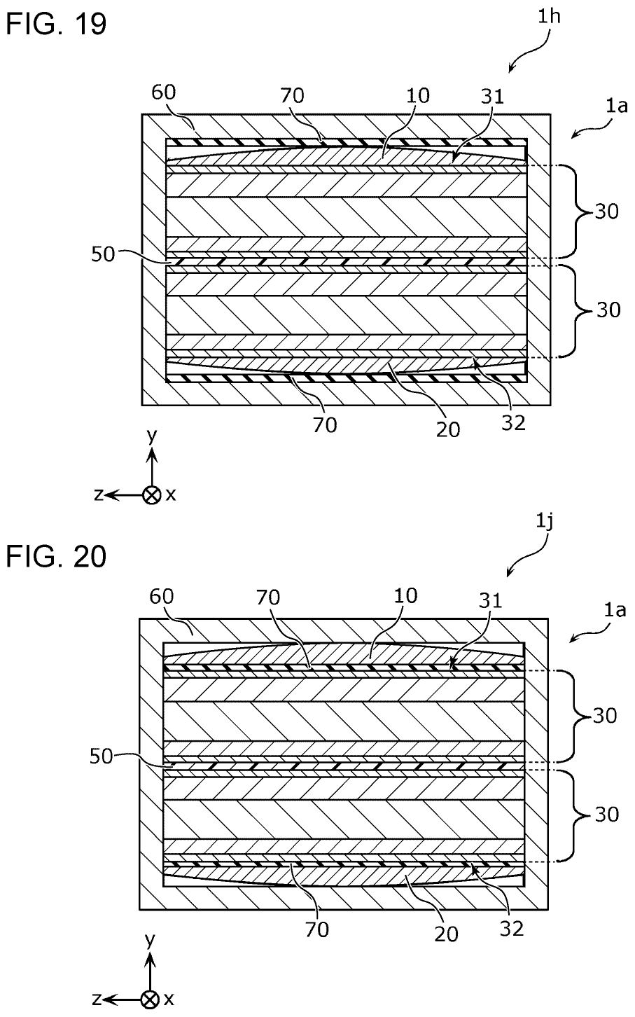

FIG. 19 is a sectional view of the battery 1h according to the third embodiment. FIG. 20 is a sectional view of the battery 1j according to the fourth embodiment.

The battery 1h according to the third embodiment includes a battery unit 1a that includes a plurality of battery cells 30, a conductive adhesive 50, a first pressing member 10, and a second pressing member 20, two insulating layers 70, and an exterior body 60.

The battery 1j according to the fourth embodiment includes a battery unit 1a that includes a plurality of battery cells 30, a conductive adhesive 50, a first pressing member 10, and a second pressing member 20, two insulating layers 70, and an exterior body 60. The battery 1h and the battery 1j are different in the positions at which the two insulating layers 70 are provided.

In the battery 1h according to the third embodiment illustrated in FIG. 19, the two insulating layers 70 are provided between the battery unit 1a and the exterior body 60. That is, one insulating layer 70 is provided above the first pressing member 10 in contact with the first pressing member 10 and the exterior body 60. The other insulating layer 70 is provided below the second pressing member 20 in contact with the second pressing member 20 and the exterior body 60.

In the battery 1j according to the fourth embodiment illustrated in FIG. 20, on the other hand, the two insulating layers 70 are provided between the plurality of battery cells 30 and the first pressing member 10 and the second pressing member 20. That is, one insulating layer 70 is provided above the upper surface 31 of the battery cell 30 and below the first pressing member 10 in contact with the upper surface 31 and the first pressing member 10. The other insulating layer 70 is provided below the lower surface 32 of the battery cell 30 and above the second pressing member 20 in contact with the lower surface 32 and the second pressing member 20.

The insulating layers 70 are layers for securing the electrical insulation between the exterior body 60 and the plurality of battery cells 30, and are constituted of a resin material, for example. The insulating layers 70 are desirably flexible insulating films, etc.

By providing the battery 1h illustrated in FIG. 19 with the insulating layers 70, it is possible to electrically insulate the exterior body 60 from the first pressing member 10 and the second pressing member 20 when the exterior body 60 and the first pressing member 10 and the second pressing member 20 are of conductive materials.

In the battery 1j illustrated in FIG. 20, by using flexible insulating films, etc., as the insulating layers 70, it is possible to press the battery cells more uniformly with the insulating layers 70 deformed when the first pressing member 10 and the second pressing member 20 press the battery cells 30. Therefore, the occurrence of damage to the battery cells 30 is suppressed. That is, a highly reliable battery 1j is achieved. Since the battery cells 30 are pressed uniformly, it is possible to reduce the contact resistance of the battery cells 30, improving battery efficiency.

### OTHER EMBODIMENTS

While the battery according to the present disclosure has been described above on the basis of embodiments, the present disclosure is not limited to such embodiments. The scope of the present disclosure also includes the embodiments modified variously as contemplated by a person skilled in the art and other forms constructed by combining constituent elements of different embodiments, without departing from the spirit and scope of the present disclosure.

A variety of changes, replacements, additions, and omissions may be made to the above embodiments within the scope of the claims and the scope of equivalence thereof.

The present disclosure is applicable to batteries for electronic devices, electric instruments and devices, and electric vehicles.

What is claimed is:

1. A battery comprising:
a battery cell including a positive electrode, a negative electrode, and a solid electrolyte layer disposed between the positive electrode and the negative electrode; and
a first pressing member in a plate shape provided above the battery cell to press the battery cell,
wherein the first pressing member includes
a first surface in a planar shape that faces the battery cell, and
a second surface in a convex shape that opposes the first surface.

2. The battery according to claim 1, further comprising
an exterior body that accommodates the battery cell and the first pressing member,
wherein the first pressing member is disposed between the exterior body and the battery cell.

3. The battery according to claim 2,
wherein the first pressing member is more rigid than the exterior body.

4. The battery according to claim 1, further comprising
a second pressing member in a plate shape provided below the battery cell to press the battery cell,
wherein the second pressing member includes
a third surface in a planar shape that faces the battery cell, and
a fourth surface that opposes the third surface.

5. The battery according to claim 4,
wherein the fourth surface is in a planar shape.

6. The battery according to claim 4,
wherein the second surface and the fourth surface have an identical shape.

7. The battery according to claim 4,
wherein the second surface and the fourth surface are shaped differently from each other.

8. The battery according to claim 4, further comprising
an exterior body that accommodates the battery cell, the first pressing member, and the second pressing member,
wherein the first pressing member and the second pressing member are more rigid than the exterior body.

9. The battery according to claim 2,
wherein a pressure inside the exterior body is lower than an atmospheric pressure.

10. The battery according to claim 1, comprising
a plurality of battery cells,
wherein the plurality of battery cells are laminated, and
the first pressing member is provided above an uppermost battery cell, of the plurality of battery cells.

11. The battery according to claim 10, further comprising
a second pressing member in a plate shape provided below a lowermost battery cell, of the plurality of battery cells, to press the plurality of battery cells,
wherein the second pressing member includes
a third surface in a planar shape that faces the plurality of battery cells, and
a fourth surface that opposes the third surface.

12. The battery according to claim 1,
wherein the convex shape is a shape including a single curved surface, and
a shape of the single curved surface is a shape of a part of a spherical surface or a shape of a part of a side surface of a circular column.

13. The battery according to claim 1,
wherein the convex shape is a shape including a plurality of curved surfaces, and
a shape of each of the plurality of curved surfaces is a shape of a part of a side surface of a circular column.
